(19) United States
(12) Patent Application Publication
(10) Pub. No.: US 2014/0067778 A1
(43) Pub. Date: Mar. 6, 2014

(54) SELECTIVE OFFLINING STORAGE MEDIA FILESYSTEM

(71) Applicants: Dhruba Borthakur, Sunnyvale, CA (US); Per Brashers, Oakland, CA (US); Song Liu, Mountain View, CA (US); Tomasz Nykiel, Palo Alto, CA (US)

(72) Inventors: Dhruba Borthakur, Sunnyvale, CA (US); Per Brashers, Oakland, CA (US); Song Liu, Mountain View, CA (US); Tomasz Nykiel, Palo Alto, CA (US)

(73) Assignee: Facebook, Inc., Menlo Park, CA (US)

(21) Appl. No.: 13/601,733

(22) Filed: Aug. 31, 2012

(51) Int. Cl. G06F 17/30

(52) U.S. Cl. 707/694; 707/E17.005

(57) ABSTRACT

A method of operation of a storage control system includes: configuring a state change policy on a data server, the state change policy including an online duration for a storage device; activating the storage device based on the state change policy; mounting the storage device based on the state change policy; and scheduling a filesystem maintenance task to be performed on the storage device based on the state change policy.

### FIELD OF INVENTION

This invention relates generally to a filesystem system, and in particular to a filesystem with multiple storage devices.

### BACKGROUND

In recent years, the need for data storage has exploded to new proportions. Inevitably with the increase in demand for data storage, data centers everywhere have to face new physical and logical challenges in managing the storage media.

Existing file system management faces challenges such as unpredictable data access, filesystem verification problems, power consumption limitations, temperature limitations, hardware space limitations, or other physical limitations. Existing file systems and their storage media drivers lack the ability to handle access to the storage media given the physical and logical limitations. However, no specific solutions have been found to resolve these challenges.

Thus, a need remains for an effective methodology to manage a file system with multiple storage media. In view of the ever-increasing commercial competitive pressures, along with growing need for data storage, it is now essential that the problems described be solved. Solutions to these problems have been long sought but prior developments have not taught or suggested any solutions. Accordingly, viable solutions to these problems have eluded those skilled in the art.

### SUMMARY

In one embodiment of the invention, a storage controller can configure a state change policy that specifies when to turn on a storage device and an online duration for the storage device. A storage driver can activate or online the storage device based on the state change policy. The storage driver can then mount the storage device based on the state change policy. Maintenance tasks, such as filesystem background processes, filesystem reports, or checksums, can be scheduled to be performed only during the online duration after the storage device is mounted.

The storage controller can have a wake/rest pattern, such as a drive of the day policy, where sets of storage devices are activated for an online duration once every timed cycle. This allows for the sets of the storage devices to fill out at approximately the same rate without having a set of the storage devices being filled up first before the others.

The storage controller can also on demand activate an offline storage device containing data from a read request or an offline device that is a target of a write request. When the offline storage device is being activated or has been activated, another storage device that is online may be deactivated simultaneously.

Some embodiments of the invention have other aspects, elements, features, and steps in addition to or in place of what is described above. These potential additions and replacements are described throughout the rest of the specification

### BRIEF DESCRIPTION OF THE DRAWINGS

FIG. 1 illustrates a selective state change storage system, in accordance with an embodiment of the invention.

FIG. 2 is an example of a block diagram of a storage control system implemented by a storage server, in accordance with an embodiment of the invention.

FIG. 3 is an example of a block diagram of a selective state change storage system implemented by a policy management module, in accordance with an embodiment of the invention.

FIG. 4 is a block diagram of an example of a state change policy.

FIG. 5 is a flow chart of a method of operation of the selective state change storage system in a further embodiment of the present invention.

FIG. 6 is a diagrammatic representation of a machine in the example form of a computer system within which a set of instructions, for causing the machine to perform any one or more of the methodologies or modules discussed herein, may be executed.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Filesystems store data on storage media, such as disks, RAM, solid state devices, or some other non-transitory physical storage device. Some filesystems assume that persistent access to the data on any of those underlying storage media, with the underlying storage media always online and ready to serve input and output (IO) requests from the filesystems. That is, those filesystems generally assume that access to data can occur at any time and when needed.

### Overview

The present invention is a selective state change storage system that can store data in multiple storage devices. A subset of those storage devices can be online while another subset of those storage devices can be offline. “Online” in the present invention refers to an active state of a device readily accessible to an external device with minimized delay. “Offline” in the present invention refers to a reduced-power mode as compared to the online devices. An offline device can be accessed by an external device after a delay longer than the minimized delay of an online device. For example, offline can refer to a spin-down mode, a sleep mode, a power off mode, or any other power saving mode of a storage device.

The selective onlining and offlining mechanism can be governed by an onlining policy, an offlining policy, or both. These policies can be referred to as state change policies. The onlining policy is a stored configurable setting that determines when and how to turn a storage device within a storage tray of the storage media system online. The offlining policy is a stored and configurable setting that determines when and how to turn a storage device within a storage tray of the storage media system offline.

Having a configurable offlining policy has been discovered to reduce the cost of storage because a storage device consumes less power in an offline state. The configurable offlining policy can be set based on access patterns. Operators of the storage media system can determine timed access patterns and translate that into the configurable offlining policy. Data security can be accomplished in this manner because data cannot be deleted if the drive policy restricts deletion during that time period or under that condition.

The configurable selective state change policy can regulate onlining activities of storage devices, offlining activities of the storage devices, storage device mounting patterns, data access patterns, data write patterns, filesystem maintenance tasks, or any combination thereof. The configurable selective state change policy can include constraints to state changes. For example, a policy can be configured where storage devices within a set must be turned online simultaneously. For another example, the policy can be configured where storage devices within the set must be turned offline simultaneously.

The periodic maintenance tasks can be aligned with the onlining or offlining of the storage devices based on the configurable offlining or onlining policy. For example, a Hadoop Distributed File System (HDFS) normally may periodically validate checksums of all the data that is stored in the filesystem. This periodic validation can occur in a continuous fashion on all underling storage devices. However with the configurable onlining and/or offlining policy, the checksum-checks can be scheduled to occur when a storage device is brought online, such as by an incoming read/write request, a wake up schedule, or a periodic wakeup pattern. The configurable onlining policy avoids having the storage device being brought online just for the sole purpose of periodic activities, such as checksum, and hence indirectly reduces overall cost of storage.

In a specific example, the present invention can be used in conjunction with HDFS to support spin-down disks. A single Hadoop machine can have hundreds of drives or disks. The drives or disks can have shared hardware. In some situations, all of these disks cannot be mounted at the same time. There are critical pieces of hardware that are shared by these disks, which means that only a portion of the disks can be mounted simultaneously. For example, in some situations one out of every fifteen disks may be mounted simultaneously. The shared hardware reduces the cost of storage, and the offlining of certain disks when they are not mounted can reduce power cost.

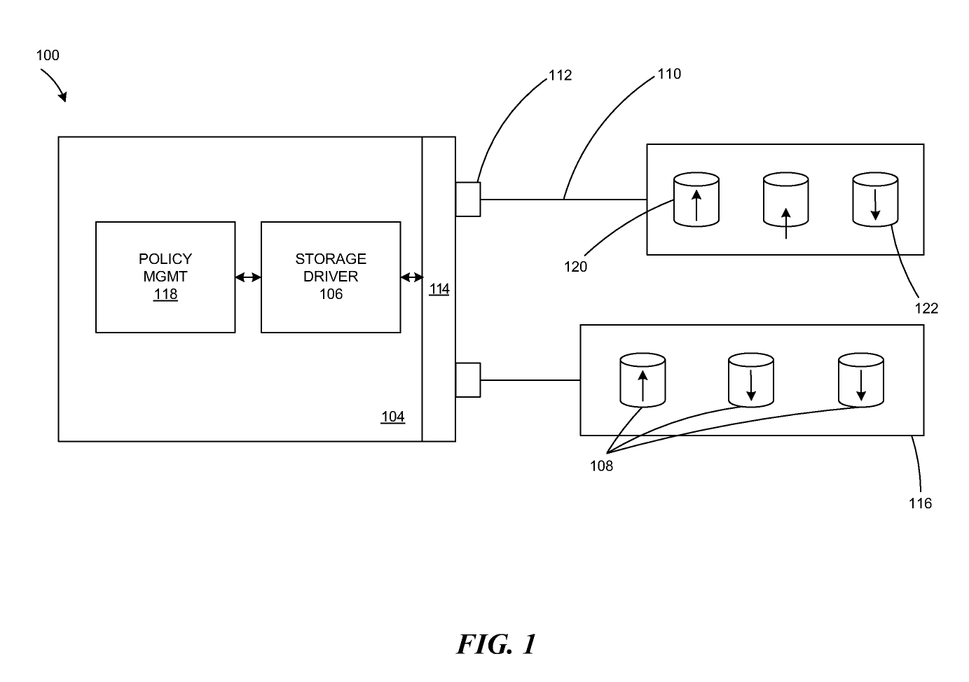

FIG. 1 illustrates a selective state change storage system 100, in accordance with an embodiment of the invention. The selective state change storage system 100 can be a filesystem or a file storage cluster that selectively activates or deactivates its storage devices. Here, “activate” can mean a process of making a storage device online and “deactivate” can mean a process of making a storage device offline.

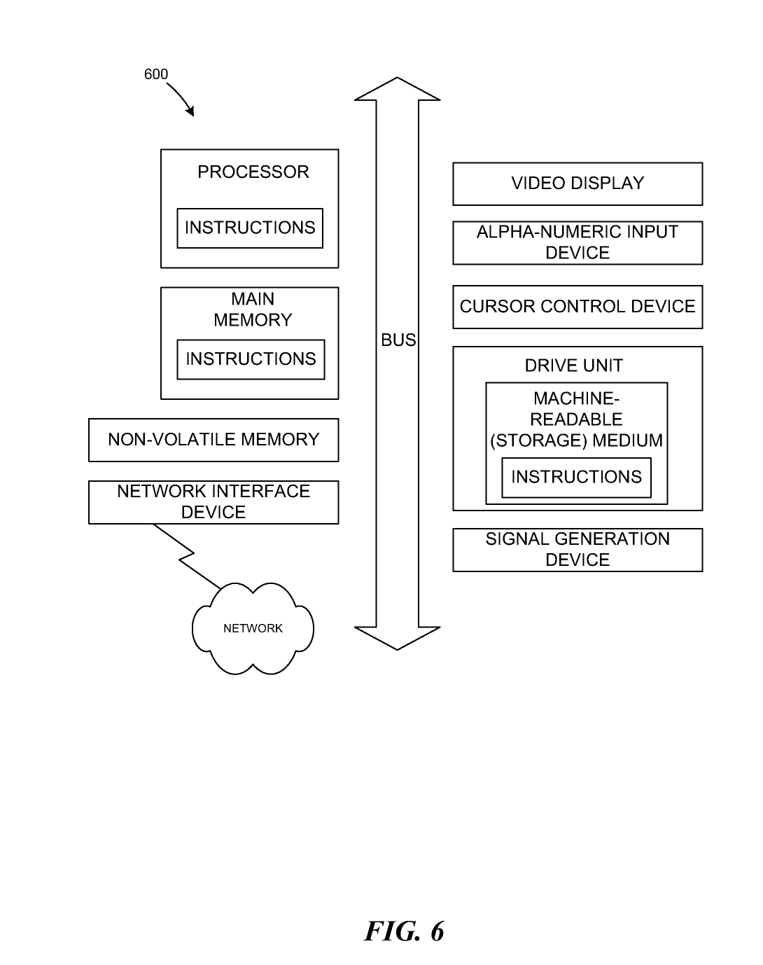

The selective state change storage system 100 can include a storage server 104. The storage server 104 is defined as a computer system for serving data to clients. The storage server 104 can be a computer system as described in FIG. 6. The storage server 104 can be, for example, a file server product, a Hadoop machine, or a computer connected to multiple storage devices.

The storage server 104 can include a storage driver 106. The storage driver 106 is defined as an adapter for accessing information from storage devices 108. The storage driver 106 can be provided by vendors of the storage devices 108. The storage driver 106 can be used to mount the storage devices 108. The storage driver 106 can facilitate access requests to the storage devices 108. The storage devices 108 can be connected via a connector hardware 110 to a communication hardware 112 on the storage server 104. The storage server 104 can include a communication switch 114 having the communication hardware 112. The communication switch 114 or the communication hardware 112 can be coupled to the storage driver 106.

The storage devices 108 are defined as any type of writable storage media. For example, the storage devices 108 can be magnetic disks or tape, optical disk (e.g., CD-ROM or DVD), flash memory, solid-state drives (SSD), electronic random access memory (RAM), micro-electro mechanical and/or any other similar media device to store information. The connector hardware 110 is defined as any type of interconnection for transferring data between the storage devices 108 and the storage driver 106. For example, the connector hardware 110 can be a network cable, an Ethernet cable, a wire, a specialized storage cable, a storage bus, Serial ATA cable, IDE cable, or any combination thereof.

The communication hardware 112 is defined as a connection interface between a server and the connector hardware 110. For example, the communication hardware 112 can be a socket on the communication switch 114 or a port on the storage server 104. The communication switch 114 is defined as an interfacing device for connecting with one or more of the connector hardware 110. For example, the communication switch 114 can be a distributed data interface, a data hub, or any other type of storage device switch.

The storage devices 108 can be organized in one or more of storage trays 116. The storage tray 116 is defined as a physical structure for holding storage devices. The storage devices 108 in the storage tray 116 can share proximate physical space as well as share some hardware, such as the connector hardware 110, cooling system, power system, or any combination thereof.

The storage server 104 can include a policy management module 118. The policy management module 118 is defined as a module on the storage server 104 for storing and executing storage management policies such as data access restrictions or storage device offlining or onlining schedules.

The storage devices 108 can be in at least two states. For example, there can be an active storage device 120. The active storage device 120 is a storage device that is active and online. The active storage device 120 can be considered as in an “online” mode. For example, the active storage device 120 can be a spin-up hard disk. An offline storage device 122 is a storage device that is not in an “online” mode. An offline storage device 122 can refer to a storage device in a lower power consuming mode as compared to the active storage device 120. The offline storage device 122 can be considered as in an “offline” mode. For example, the offline storage device 122 can be a power-off storage device, a storage device in sleep mode, a storage device in a passive or an active standby mode, or a hard disk that has spun down.

The state changes between online and offline mode can be made by software, electronic hardware, or a mechanical switch. Because the activation time to go into online mode and the deactivation time to go into offline mode can vary, the policy management module 118 may account for these time differences such that before a new set of storage devices are fully online, the online process of an additional set of storage devices is not initiated. That is, the policy management module 118 is not bound to keep drives in an online/spin-up state, but that the policy management module 118 can be bound not to have more than one set in a transition state at once. Alternatively, before an old set of storage devices are fully offline, initiation of the online process of the new set of storage devices can be postponed.

Mounting and unmounting of the storage devices 108 can be synchronized with the activation and deactivation of the storage devices 108, respectively. For example, a storage device can be mounted after it is fully online. A storage device can be unmounted simultaneously, immediately before, or immediately after the deactivation process for the storage device.

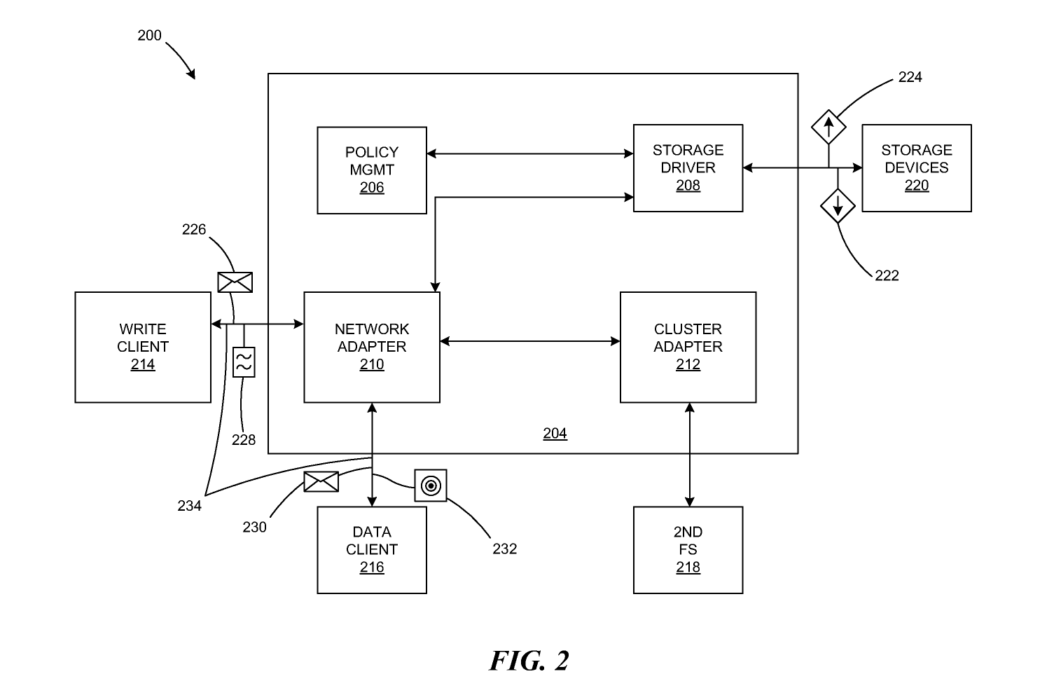

FIG. 2 illustrates a block diagram of a storage control system 200 implemented by a storage server 204, in accordance with an embodiment of the invention. The storage control system 200 can be a filesystem, such as a filesystem with an offlining policy. The storage control system 200 can be the selective state change storage system 100 of FIG. 1. The storage control system 200 can be embodied as a single- or multi-processor storage system executing a storage operating system. The storage control system 200 can logically manage and organize information as a hierarchical structure, such as in named directories, files, or blocks.

The storage server 204 can be a storage controller or a filesystem server. The storage server 204 is defined as a computer system for serving data to clients. The storage server 204 can be a computer system described in FIG. 6 or the storage server 104 of FIG. 1.

The storage control system 200 can include one or more methods of managing a storage access policy. The one or more methods can be implemented by components, storages, and modules described below. The modules can be implemented as hardware modules, software modules, or any combination thereof. For example, the modules described can be software modules implemented as instructions on a non-transitory memory capable of being executed by a processor or a controller on a machine described in FIG. 6. The storages, each labeled as a “store”, described below are hardware components for storing data, such as storing digital data. Each of the stores can be on separate physical device or share the same physical device or devices.

The storage control system 200 can include additional, fewer, or different modules for various applications. Conventional components such as network interfaces, security functions, load balancers, failover servers, management and network operations consoles, and the like are not shown so as to not obscure the details of the system. The storage server 204 can include a policy management module 206, a storage driver 208, a network adapter 210, a cluster adapter 212, or any combination thereof. The storage devices 220 are defined as any type of storage media. For example, the storage devices 220 can be the storage devices 108 of FIG. 1. The storage server 204 can be coupled to a writer client 214, a data client 216, a second filesystem 218, storage devices 220, or any combination thereof.

The writer client 214 is defined as a computer system that has data to record onto at least one of the storage devices 220. The writer client 214 can be a computer system described in FIG. 6. The data client 216 is defined as a computer system that has data to read from one of the storage devices 220. The data client 216 can be a computer system described in FIG. 6. The write client 214 and the data client 216 can be the same computer system.

The storage server 204 can make some or all of the storage space on the storage devices 220 available to the data client 216 and the write client 214. Each of the storage devices 220 can be implemented as, for example, an individual disk, multiple disks (e.g., a RAID group) or any other suitable mass storage device. The storage server 204 can communicate with the write client 214 and the data client 216 according to protocols such as the Network File System (NFS) protocol, the Common Internet File System (CIFS) protocol, HDFS, Linear Tape File System (LTFS), or any other file system protocol, to make data stored on the storage devices 220 available to users or application programs. The storage server 204 can present or export data stored on the storage devices 220 as volumes to each of clients.

The second filesystem 218 is defined as another storage server that can work in conjunction with the storage server 204 to provide data access to storage devices connected to the second filesystem 218. The second filesystem 218 can be a computer system described in FIG. 6.

The policy management module 206 is defined as a module on the storage server 204 for storing and executing storage management policies, such as data access restrictions or storage device offlining or onlining schedules. The policy management module 206 can be the policy management module 118 of FIG. 1. The policy management module 206 can be coupled to the storage driver 208.

The storage driver 208 is defined as an adapter for accessing information from the storage devices 220. The storage driver 208 can be the storage driver 106 of FIG. 1. The policy management module 206 can determine when the storage driver 208 is to mount one of the storage devices 220.

For example, the policy management module 206 can determine that a “disk 1” of the storage devices 220 is to be activated to the online mode and mounted every Monday of the week. The policy management module 206 can determine when the storage driver 208 is to allow read access to the storage devices 220 and which one of the storage devices 220 to allow access. For example, the policy management module 206 can determine that the storage driver 208 can access the “disk 1” for data reads on each Monday. The policy management module 206 can also determine when the storage driver 208 is to allow write access to the storage devices 220 and which one of the storage devices 220 to allow access. For example, the storage driver 208 can allow access to the “disk 1” for data writes on each Monday.

When data reads and data writes are allowed can be determined by an onlining policy or offlining policy of the storage devices 220. That is, data reads and data writes to particular storage devices are scheduled and allowed only during an online duration of the particular storage devices.

Alternatively, the policy management module 206 can allow a read request or a write request to activate an offline storage device. Under that policy, the read request or the write request for data on a particular storage device can trigger an activation process of the particular storage device.

The policy management module 206 can also determine when maintenance activities for the storage devices 220 be performed through the storage driver 208, and which one or ones of the storage devices 220 are to perform the maintenance activities. Maintenance activities are defined as background processes for a filesystem. Maintenance activities can include at least checksum verification, filesystem report, periodic scan, deduplication process, or defragmentation process. For example, a check-sum maintenance activity can be scheduled to be performed every Monday of the week for the “disk 1,” when the disk is mounted. The policy management module 206 may prevent or restrict some of the maintenance activities from occurring, such as a deduplication process.

For another example, a block report process may occur in a filesystem. The block report can scan each of the storage devices 220 to determine all of the information and data on that storage device. When a storage device is online, the policy management module 206 can schedule the block report to be performed and stored on a non-transitory memory or cache. When the storage device is offline, the policy management module 206 can then re-route block report requests to the non-transitory memory or cache to access the stored block report.

The policy management module 206 can determine when to send an offline signal 222 to one or more of the storage devices 220. The offline signal 222 is defined as a message for sending to one or more of the storage devices 220 to turn the storage devices 220 into an offline mode, such as a sleep mode, a power-saving mode, a power-off mode, a suspend mode, a standby mode, or a spin down mode.

The policy management module 206 can determine when to send an online signal 224 to one or more of the storage devices 220. The online signal 224 is defined as a message for sending to one or more of the storage devices 220 to turn the storage devices 220 into an online mode, such as an active mode, a power-on mode, a spin up mode, or a non-power-saving model. For example, the online signal 224 can be sent at beginning of every Monday of the week and the offline signal 222 can be sent at the end of every Monday of the week for the “disk 1.” The online signal 224 and the offline signal 222 can be sent from through the storage driver 208.

The network adapter 210 can be coupled to the storage driver 208. The network adapter 210 can forward read or write requests to the storage driver 208. For example, the network adapter 210 can be coupled to the writer client 214 to receive a write request 226. The write request 226 is a message for sending to the network adapter 210 to notify the storage server 204 that the writer client 214 intends on writing to one or more of the storage devices 220. For example, the write request 226 can be a message to the network adapter 210 to record a write pattern 228 to the one or more of the storage devices 220. The network adapter 210 can check with the storage driver 208 to determine which one of the storage devices 220 to write to, in accordance with the policies defined in the policy management module 206. The storage driver 208 can then record the write pattern 228 onto the determined storage device. When the determined storage device is not in an online state, the storage driver 208 can send an online signal 224 to activate the determined storage device and mount it.

The network adapter 210 can also be coupled to the data client 216 to receive a data request 230. The data request 230 is a message for sending to the network adapter 210 to notify the storage server 204 that the data client 216 intends to access the storage devices 220. For example, the data request 230 can be a message to the network adapter 210 to access a read target 232 from the storage devices 220. The read target 232 may be in one or more of the storage devices 220. The network adapter 210 can check with the storage driver 208 to determine if the read target 232 is contained in one of active online storage devices, such as the active storage device 120 of FIG. 1. If so, the storage driver 208 can access and return the read target 232 to the data client 216. If not, the storage driver 208 can notify the data client 216 that the read target 232 cannot be accessed at the time. Alternatively, if not, the storage driver 208 can activate and mount the one or more of the storage devices 220 to access and return the read target 232.

The cluster adapter 212 is defined as a module in the storage server 204 for managing a storage cluster. For example, the storage server 204 can exist within a network data storage environment. Within the network data storage environment, other suitable combinations of storage servers, mass storage devices, and any other suitable network technologies may be employed. The cluster adapter 212 can have one or more ports for coupling the storage server 204 to other storage systems or file systems, such as the second filesystem 218. The second filesystem 218 can be connected to the storage server 204 via a network channel, a network switch fabric, a switch, or any combination thereof. For example, the network channel can be Ethernet, Internet, or any other communication system. In some embodiments, the storage devices can be connected to the storage servers such that not all storage servers are aware of all storage devices.

The data client 216, the write client 214, the second filesystem 218, or any combination thereof can communicate with the storage server 204 via a network channel 234. For example, the network channel 234 can be an Ethernet or other wire-based network or a wireless NIC (WNIC) or wireless adapter for communicating with a wireless network, such as a WI-FI network. The network channel 234 can be any suitable network for any suitable communication interface. As an example and not by way of limitation, the network channel 234 can be an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless.

In one embodiment, the network channel 234 uses standard communication technologies and/or protocols. Thus, the network channel 234 can include links using technologies such as Ethernet, 802.11, worldwide interoperability for microwave access (WiMAX), 3G, 4G, CDMA, digital subscriber line (DSL), etc. Similarly, the networking protocols used on the network channel 234 can include HDFS, NFS, CIFS, LTFS, or other filesystem networking protocols. The networking protocols used can also be non-filesystem protocols including multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network channel 234 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

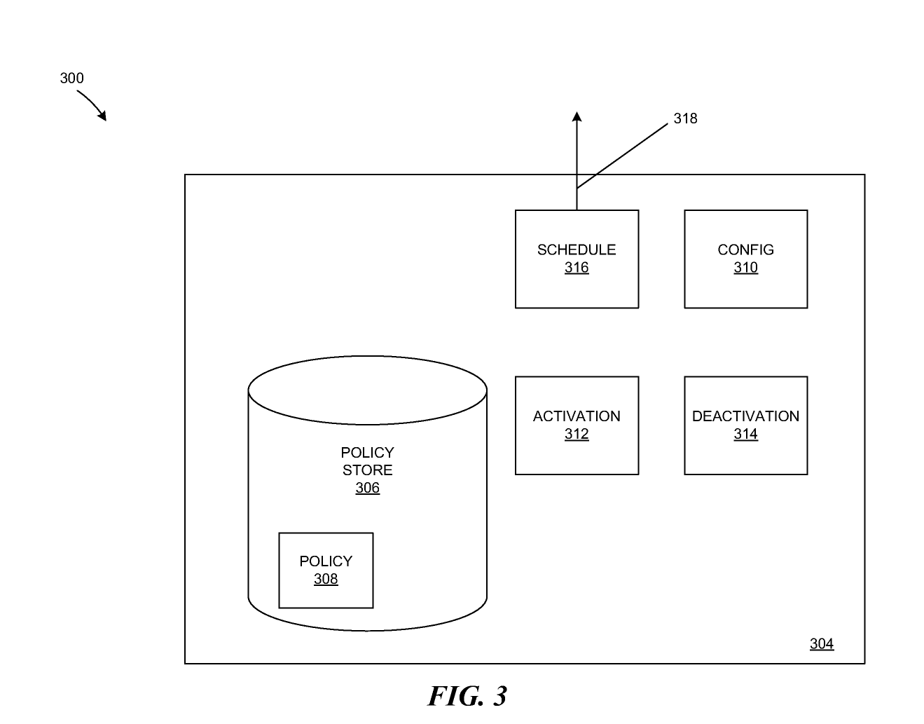

FIG. 3 illustrates a block diagram of a selective state change storage system 300 implemented by a policy management module 304, in accordance with an embodiment of the invention. The policy management module 304 is defined as a module on a computer system for storing and executing storage management policies, such as data access restrictions or storage device offlining or onlining schedules. The policy management module 304 can be the policy management module 118 of FIG. 1 or the policy management module 206 of FIG. 2.

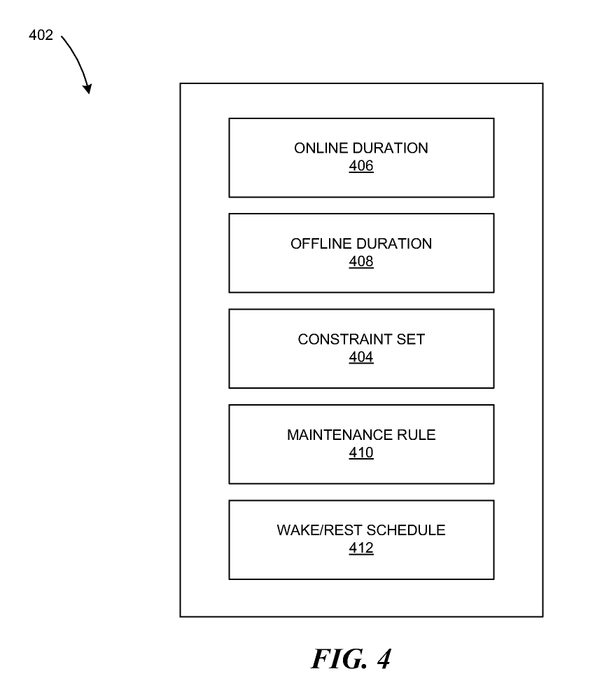

The policy management module 304 can include a policy store 306. The policy store 306 is defined as a non-transitory memory storing storage device management policies, such as a state change policy 308. The state change policy 308 is defined as a set of storage management rules. For example, the state change policy 308 can include a data access restriction, a storage device onlining or offlining schedule, an access pattern, a state change pattern, a filesystem maintenance task schedule, or any combination thereof. The state change policy 308 can include a rule that dictates a schedule for when and how a storage device has to change its state of operation (e.g. online or offline). An example of the state change policy 308 is provided in FIG. 4. The state change policy 308 can be configured by an operator of the selective state change storage system 300, such as through a user interface. The user interface can include a keyboard, a touch screen, a mouse, or any combination thereof.

The policy management module 304 can include a configuration module 310. The configuration module 310 is for facilitating an interface to create or modify the state change policy 308. For example, an operator of the storage server 204 of FIG. 2 can modify the state change policy 308 on the policy store 306 by selecting from a calendar one or more of the storage devices 220 of FIG. 2 to activate. The configuration module 310 can also provide an interface for another computer system to configure the state change policy 308. For example, the configuration module 310 can provide an application programming interface (API) for backup applications and data analysis applications.

The policy management module 304 can include an activation module 312. The activation module 312 is for activating a storage device based on an online policy of the state change policy 308. For example, the activation module 312 based on the state change policy 308 can execute a schedule of activating one or more of the storage devices 220 of FIG. 2 every three months. Upon activation, the policy management module 304 can instruct a storage driver, such as the storage driver 208 of FIG. 2, to mount the storage device based on the state change policy 308. Activation is defined as changing the state of a storage device to an online mode. The online mode can be a state of operating a storage device when it is fully activated and functional. The activation module 312 can generate and/or send the online signal 224 of FIG. 2.

The policy management module 304 can include a deactivation module 314. The deactivation module 314 is for deactivating a storage based on an offline policy of the state change policy 308. For example, the deactivation module 314 based on the state change policy 308 can execute a schedule for deactivating one or more of the storage devices 220 of FIG. 2 after two days of operation. Deactivation is defined as changing the state of a storage device to an offline mode. The offline mode can be a state of operating a storage device at a reduced power consumption state. The deactivation module 314 can generate or send the offline signal 222 of FIG. 2.

The policy management module 304 can include a schedule module 316. The schedule module 316 is for scheduling a filesystem task 318 to be performed on the storage device based on the state change policy 308. For example, the schedule module 316 can queue up disk verification tasks to be performed on each of the storage devices 220 of FIG. 2, and execute the disk verification tasks when each of the storage devices 220 is activated.

FIG. 4 illustrates a block diagram of an example of a state change policy 402. The state change policy 402 is defined as a set of storage management rules, such as data access restrictions or storage device offlining or onlining schedules. The state change policy 402 can be the state change policy 308 of FIG. 3. The state change policy 402 includes a set of offlining policy for storage devices. The state change policy 402 can also include a set of onlining policy for storage devices.

The state change policy 402 can include a similar-constraint set 404. The similar-constraint set 404 is defined as a set of storage devices that can share the same state change policy. For example, first storage device of each tray of storage device can be considered within one of the similar-constraint set 404. The state change policy 402 can dictate that the similar-constraint set 404 of storage devices be activated or deactivated, simultaneously. The similar-constraint set 404 can be defined by identification of the storage devices, a property or parameter of the storage devices, a location of the storage devices, an order or sequence of the storage devices, or any combination thereof.

The state change policy 402 can include an online duration 406. The online duration 406 is defined as a preset amount of time for a storage device to stay in the online mode. However, even in online mode, the state change policy 402 can restrict the similar-constraint set 404 of storage devices to be either read-only, write-only, or read-and-write. The online duration 406 can be specific to a storage device, specific to the similar-constraint set 404, specific to a tray, such as the storage tray 116 of FIG. 1, or general to all of storage devices for a storage server. For example, the online duration 406 can be one hour for a specific storage device called “disk Z.” For another example, the online duration 406 can be one day for a set of storage devices.

The state change policy 402 can include an offline duration 408. The offline duration 408 is defined as a preset amount of time for a storage device to stay in an offline mode. The offline mode can include powering down a storage device while retaining its memory state. The offline duration 408 can be specific to a storage device, specific to the similar-constraint set 404, specific to a tray, such as the storage tray 116 of FIG. 1, or general to all of storage devices for a storage server. For example, the offline duration 408 can be six days for storage devices in a specific storage device tray.

The state change policy 402 can include maintenance rules 410. The maintenance rules 410 is defined as specific rules on how to deal with maintenance tasks when one or more of the storage devices are in offline mode. For example, the maintenance rules 410 can include a rule such that a checksum check is made only when a storage device is already in the online mode.

The state change policy 402 can include a wake/rest schedule 412. The wake/rest schedule 412 is defined as a rule of activating one or more storage device at a predefined specific time for a predefined specific time duration. For example, the wake/rest schedule 412 can be a calendar for waking up a storage device identified by a tray identification or a storage device identification. The one or more storage devices can be defined by the similar-constraint set 404. New write requests can be routed to the one or more storage devices that are awake for the predefined time duration. Periodic deleting of file blocks can also be scheduled together with the wake/rest schedule 412. Furthermore, the maintenance tasks and background processes of the filesystem can also be scheduled together with the wake/rest schedule 412.

For example, the wake/rest schedule 412 can include a wake/rest cycle pattern. The wake/rest cycle pattern is defined as a schedule to activate one or more storage devices after lapse of a predefined time period for a predefined time duration. The predefined time period can be, for example, a day, a month, or a year. The predefined time duration can be, for example, an hour, a day, or a week.

For example, the wake/rest cycle pattern can be a drive of the day schedule. A drive (i.e., a storage device) can be woken up once every week for a day for storing all of the data from a backup application or a data warehouse during that day. Read requests and background filesystem processes can also be executed on the drive of the day. The advantage of the drive of the day schedule is that because storage devices are cycled through each week, the storage devices get filled up at approximately the same rate. This serves to load balance the storage devices and increase the performance of the overall filesystem.

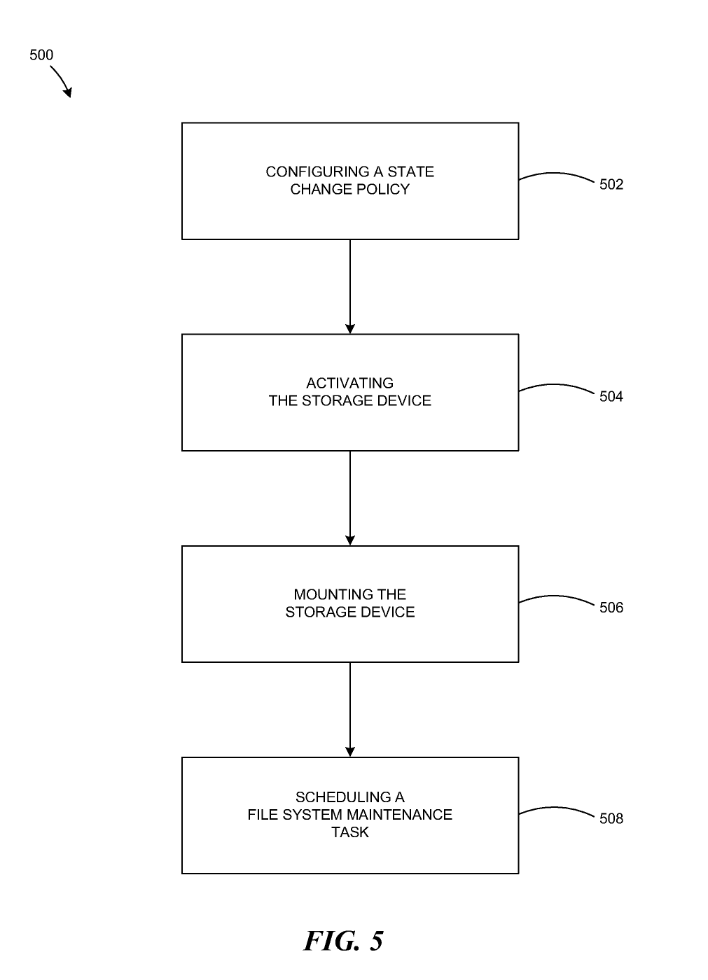

FIG. 5 illustrates a flow chart of a method 500 of operation of the selective state change storage system 100 in a further embodiment of the present invention. The method 500 includes: configuring a state change policy on a data server, the state change policy including an online duration for a storage device in a method step 402; activating the storage device based on the state change policy in a method step 404; mounting the storage device based on the state change policy in a method step 406; and scheduling a filesystem maintenance task to be performed on the storage device based on the state change policy in a method step 408.

Referring now to FIG. 6, therein is shown a diagrammatic representation of a machine in the example form of a computer system 600 within which a set of instructions, for causing the machine to perform any one or more of the methodologies or modules discussed herein, may be executed.

In the example of FIG. 6, the computer system 600 includes a processor, memory, non-volatile memory, and an interface device. Various common components (e.g., cache memory) are omitted for illustrative simplicity. The computer system 600 is intended to illustrate a hardware device on which any of the components depicted in the example of FIGS. 1-3 (and any other components described in this specification) can be implemented. The computer system 600 can be of any applicable known or convenient type. The components of the computer system 600 can be coupled together via a bus or through some other known or convenient device.

This disclosure contemplates the computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 600 may include one or more computer systems 600; be unitary or distributed; span multiple locations; span multiple machines; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 600. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 600. The interface can include an analog modem, isdn modem, cable modem, token ring interface, satellite transmission interface (e.g. “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 6 reside in the interface.

In operation, the computer system 600 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing are intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the invention to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

While processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method comprising:
configuring a state change policy for a storage device on a data server including multiple storage devices, the state change policy including an online duration for the storage device;
activating, based on the state change policy, the storage device;
determining, based on the state change policy, a first time a storage driver of the data server is to mount the storage device; and
scheduling, based on the state change policy, at a second time that is before the first time, a filesystem maintenance task that is to be performed, at a third time that is after the first time, on the storage device, wherein the filesystem maintenance task involves a background process to maintain a first filesystem of the storage device.

2. The method of claim 1, wherein configuring the state change policy includes configuring the state change policy to allow for only sequential write access to the storage device within the online duration.

3. The method of claim 1, wherein scheduling the filesystem maintenance task includes scheduling the filesystem maintenance task to be performed on the storage device within the online duration.

4. The method of claim 1, further comprising caching a filesystem report of the storage device on the data server within the online duration for access in an offline duration of the storage device.

5. The method of claim 1, wherein the storage device is mounted by attaching the first filesystem of the storage device to a currently accessible filesystem of the data server to gain access to data within the storage device.

6. A method comprising:
configuring an offline policy for a storage device on a data server including multiple storage devices, the offline policy including an offline duration for the storage device;
deactivating, based on the offline policy, the storage device;
determining, based on the offline policy, a first time a storage driver of the data server is to unmount the storage device; and
postponing, based on the offline policy, at a second time before the first time, a filesystem maintenance task that is to be performed on the storage device, at a third time that is before the first time, wherein the filesystem maintenance task involves a background process to maintain a filesystem of the storage device.

7. The method of claim 6, wherein configuring the offline policy includes configuring the offline policy for setting a cycle pattern to deactivate the storage device.

8. The method of claim 6,
wherein configuring the offline policy includes configuring the offline policy with a set of storage devices not to be deactivated simultaneously; and
wherein deactivating the storage device includes determining based on the offline policy whether the storage device is within the set.

9. The method of claim 6, further comprising activating the storage device when a read or write request is received at the data server for data on the storage device.

10. The method of claim 6, wherein deactivating the storage device includes suspending the storage device.

11. A storage system comprising:
multiple storage devices;
a policy store including a state change policy for a first storage device of the multiple storage devices, the state change policy including an online duration and an offline duration for the first storage device;
an activation module, coupled to the policy store, for activating, based on the state change policy, the first storage device;
a storage driver for mounting, based on the state change policy, the first storage device; and
a schedule module, coupled to the policy store, for scheduling, based on the state change policy, a filesystem maintenance task that is to be performed on the first storage device, wherein the filesystem maintenance task involves a background process to maintain a filesystem of the storage device.

12. The storage system of claim 11, wherein the state change policy includes a rule for allowing for only sequential write access to the first storage device within the online duration.

13. The storage system of claim 11, wherein the schedule module is for scheduling the filesystem maintenance task to be performed on the first storage device within the online duration.

14. The storage system of claim 11, wherein the storage driver is for caching a filesystem report of the first storage device on the data server within the online duration for access in an offline duration of the first storage device.

15. The storage system of claim 11, further comprising a deactivation module for spinning down the first storage device after the online duration is over.

16. The storage system of claim 11, wherein the policy store includes an offline policy, the offline policy including an offline duration for the first storage device on the device tray; wherein the storage driver is for unmounting the first storage device based on the offline policy; and wherein the schedule module is for postponing the filesystem maintenance task to be performed on the first storage device based on the offline policy; and
the storage system further comprising:
a deactivation module, coupled to the policy store, for deactivating the first storage device based on the offline policy;

17. The storage system of claim 16, wherein the offline policy is for setting a cycle pattern to deactivate the first storage device.

18. The storage system of claim 16,
wherein the offline policy includes a set of storage devices not to be deactivated simultaneously; and
wherein the deactivation module is for determining based on the offline policy whether the first storage device is within the set.

19. The storage system of claim 16, wherein the activation module is for activating the first storage device when a read or write request is received at the data server for data on the first storage device.

20. The storage system of claim 16, wherein the deactivation module is for suspending the first storage device.

21. The method of claim 1, wherein the filesystem maintenance task is a checksum verification process for the first filesystem.

22. The method of claim 1, wherein the filesystem maintenance task is a filesystem reporting process for the first filesystem.

23. The method of claim 1, wherein the filesystem maintenance task is a defragmentation process for the first filesystem.

24. The method of claim 1, wherein the filesystem maintenance task is a deduplication process of the first filesystem.

25. The method of claim 1, wherein the filesystem maintenance task is a scanning process of the first filesystem.
